(19) United States
(12) Patent Application Publication
(10) Pub. No.: US 2012/0320271 A1
(43) Pub. Date: Dec. 20, 2012

(54) ELECTRONIC DEVICE AND METHOD FOR FAST STARTING WIDGETS THEREOF

(75) Inventors: CHIH-LUNG CHEN, Tu-Cheng (TW); CHIH-HUNG WENG, Tu-Cheng (TW)

(73) Assignee: HON HAI PRECISION INDUSTRY CO., LTD., Tu-Cheng (TW)

(21) Appl. No.: 13/237,963

(22) Filed: Sep. 21, 2011

(30) Foreign Application Priority Data
Jun. 15, 2011 (TW) 100120811

(51) Int. Cl. H04N 5/445; H04N 5/44

(52) U.S. Cl. 348/563; 348/734; 348/E05.103; 348/E05.096

(57) ABSTRACT

An electronic device comprising a plurality of widgets is controlled by a remote controller. The remote controller comprises a plurality of keys. The widgets are associated with the keys of the remote controller. When one of the keys of the remote controller is pressed for a predefined time period, one of the widgets associated with the pressed key is started.

### BACKGROUND

1. Technical Field

The present disclosure relates to electronic devices, and more particularly to an electronic device and a method for fast starting widgets thereof.

2. Description of Related Art

Currently, electronic devices such as connected TVs provide many widgets to broaden user applications. If a user wants to start one of the widgets, the user must press a “widget” key of a remote controller to control a corresponding TV to enter a widget browsing mode and subsequently display a widget menu. Then, the user must press a Left or Right key of the remote controller to choose the one of the widgets from the widget menu, and finally press an Enter key to start the chosen widget. Thus, the user has to press more than one key to start the one widget, which is rather inconvenient.

### BRIEF DESCRIPTION OF THE DRAWINGS

The details of the disclosure, both as to its structure and operation, can be best understood by referring to the accompanying drawing, in which like reference numbers and designations refer to like elements.

FIG. 1 is a schematic diagram of an application environment and functional modules of one embodiment of an electronic device in accordance with the present disclosure;

FIG. 2 is a schematic diagram of one embodiment of an association relationship between widgets of the electronic device and keys of a remote controller in accordance with the present disclosure;

FIG. 3 is a schematic diagram of a display interface of one embodiment of the electronic device in a full screen TV mode with at least one widget in accordance with the present disclosure;

FIG. 4 is a schematic diagram of a display interface of one embodiment of the electronic device in a widget browsing mode in accordance with the present disclosure;

FIG. 5 is a schematic diagram of a display interface of another embodiment of the electronic device in the widget browsing mode in accordance with the present disclosure;

FIG. 6 is a flowchart of one embodiment of a method for starting or closing widgets when the electronic device is in the full screen TV mode in accordance with the present disclosure; and

FIG. 7 is a flowchart of one embodiment of a method for setting the association relationship between the widgets of the electronic device and the keys of the remote controller when the electronic device is in the widget browsing mode in accordance with the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

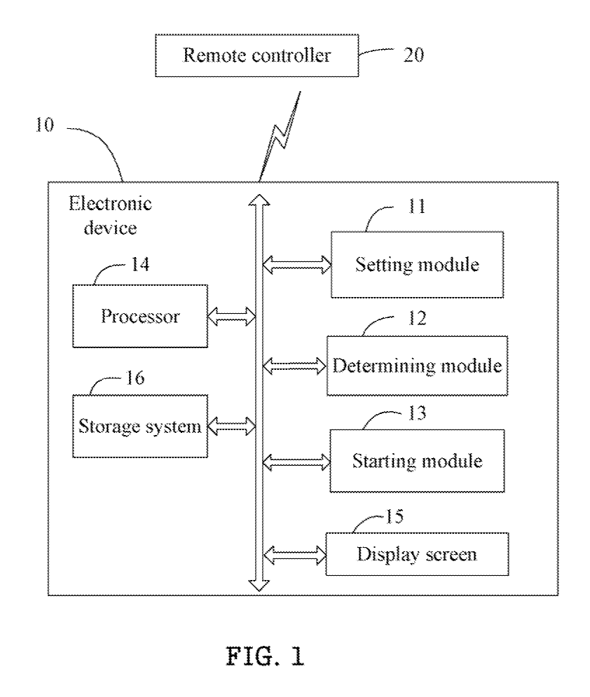

FIG. 1 is a schematic diagram of an application environment and functional modules of one embodiment of an electronic device 10 in accordance with the present disclosure. In one embodiment, the electronic device 10 may be a connected TV, an IP set-top box, or another electronic device that can be connected to the Internet. The electronic device 10 comprises a plurality of widgets to obtain information such as news, time, and weather from the Internet. In the embodiment, the electronic device 10 is controlled by a remote controller 20. In detail, the remote controller 20 can not only control the electronic device 10 to shift channels, but also start required widgets of the electronic device 10.

In one embodiment, the electronic device 10 includes a setting module 11, a determining module 12, a starting module 13, a display screen 15, at least one processor 14, and a storage system 16 (e.g., flash memory or a hard disk drive). The modules 11-13 may comprise computerized code in the form of one or more programs that are stored in the storage system 16. The computerized code includes instructions that are executed by the at least one processor 14 to provide functions for the modules 11-13. The display screen 15 is operable to display TV programs and widgets.

In one embodiment, the electronic device 10 includes a full screen TV mode and a widget browsing mode. The full screen TV mode is the mode that the video can occupy the full screen of TV. The widget browsing mode is the mode that the plurality of widgets can be displayed on the display screen. The starting module 13 is operable to selectively start or close widgets when the electronic device 10 is in the full screen TV mode. The setting module 11 is operable to set an association relationship between the widgets and the keys of the remote controller 20 when the electronic device 10 is in the widget browsing mode. In detail, the setting module 11 is operable to add, modify, and remove the association relationship between the widgets and the keys of the remote controller 20.

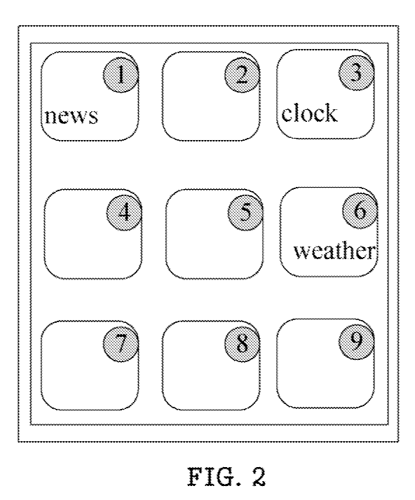

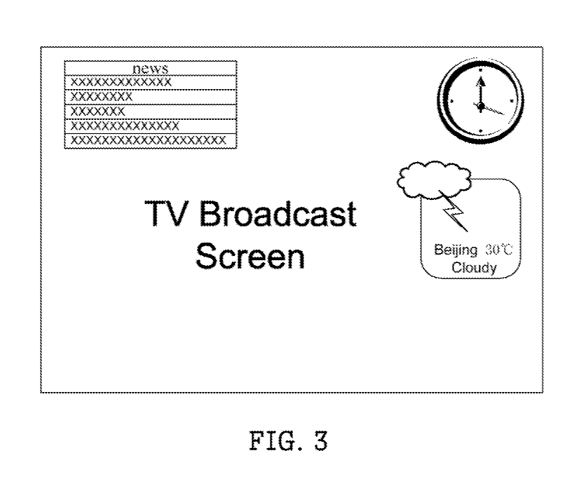

In one embodiment, the setting module 11 sets widgets to associate with number keys 1-9 of the remote controller 20. The widgets are arranged in the display screen 15 in a particular way like a style box. Positions of the widgets displaying on the display screen 15 correspond to positions of the associated number keys 1-9 in the remote controller 20. For example, referring to FIG. 2, the setting module 11 sets the number keys 1, 3, and 6 of the remote controller 20 to associate with news, clock, and weather widgets, respectively. Similarly, the setting module 11 can also set other keys of the remote controller 20 to associate with other widgets. For example, if a user wants to start the news, clock, and weather widgets when the electronic device 10 is in the full screen TV mode, the user only needs to press the keys 1, 3, and 6 of the remote controller 20 associated with the news, clock, and weather widgets for a predefined time period, such as 3 second. Then, the news, clock, and weather widgets would be started and displayed in the display screen 15. A corresponding display interface is showed in FIG. 3. In general, the user only needs to press one key for a predefined time period then a corresponding expected widget would be started, which is convenient for the user and improves user experience. In the embodiment, the predefined time period is set as 3 second. In other embodiments, the predefined time period could be set to different time periods, depending on different system conditions of the electronic device 10 or different actual demands of users.

In the embodiment, if a user wants to close a started widget, such as the news widget, the user only needs to press the associated key, for example the number key 1, of the remote controller 20 for the predefined time period again, and then the news widget would be closed. Similarly, the user can close other started widgets using the same method. In general, the user only needs to press one key for the predefined time period to close the started widget, which is convenient for the user and improves user experience.

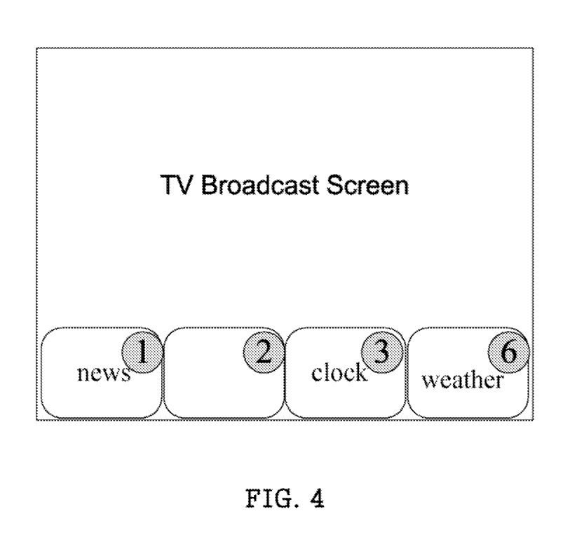

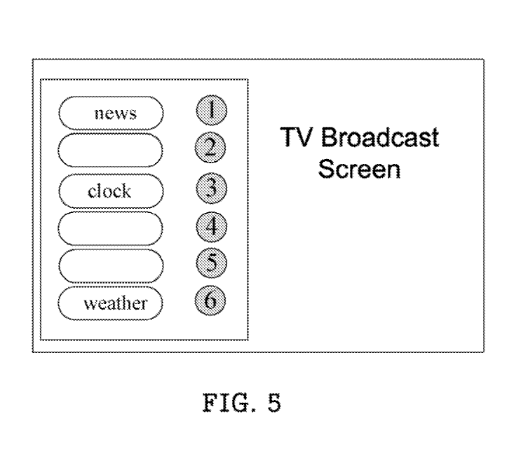

In the embodiment, the setting module 11 is further operable to add, modify or remove the association relationship between the widgets and the keys of the remote controller 20. For example, the plurality of widgets can be displayed on the display screen 15 as shown in FIG. 4 or FIG. 5. The setting module 11 has set the news, clock, and weather widgets to be associated with the number keys 1, 3, and 6 of the remote controller 20, respectively.

If a user wants to change the news widget to associate with the number key 2 of the remote controller 20, the user only needs to enter the widget browsing mode and choose the news widget, and then press the number key 2 of the remote controller 20 for the predefined time period. In this way, the setting module 11 successfully sets the news widget to associate with the number key 2 of the remote controller 20. Simultaneously, the setting module 11 removes the association relationship between the news widget and the number key 1 of the remote controller 20. In general, the user only needs to press one key for the predefined time period to change the association relationship between the pressed key and one widget, which is very convenient for the user.

If a user wants to remove the association relationship between a widget and one associated key, such as the association relationship between the clock widget and the number key 3 of the remote controller 20, the user only needs to enter the widget browsing mode and choose the clock widget, and press the number key 3 of the remote controller 20 for the predefined time period. In this way, the setting module 11 successfully removes the association relationship between the clock widget and the number key 3 of the remote controller 20. Similarly, the user can also remove relationship between other widgets and other associated keys of the remote controller 20. In general, the user only needs to press one key for a predefined time period to remove the association relationship between the pressed key and the associated widget, which is convenient for the user and improves user experience. [same hereinafter]

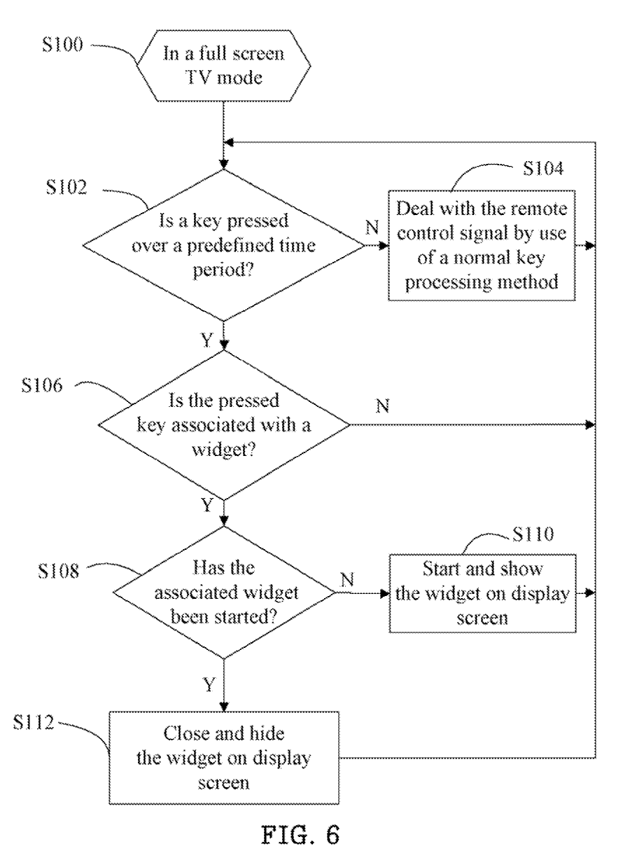

FIG. 6 is a flowchart of one embodiment of a method for starting or closing widgets when the electronic device 10 is in the full screen TV mode in accordance with the present disclosure. The method may be embodied in the electronic device 10, and is executed by the functional modules such as those of FIG. 1. Depending on the embodiment, additional blocks may be added, others deleted, and the ordering of the blocks may be changed while remaining well within the scope of the disclosure.

In block S100, the electronic device 10 is started and enters a full screen TV mode.

In block S102, the determining module 12 determines receive a remote control signal that is indicative of a pressed key of the remote controller 20, and whether the pressed key is pressed for a predefined time period.

If the determining module 12 receives a remote control signal comprising one key of the remote controller 20 is pressed, but the pressed key is not pressed for the predefined time period, then in block S104, the determining module 12 deals with the remote control signal by use of a normal key processing method. For example, if the determining module 12 receives a remote control signal that the number key 1 of the remote controller 20 is pressed, but the key is not pressed for the predefined time period, then the electronic device 20 shifts channel to channel 1.

If the determining module 12 receives a remote control signal comprising one key of the remote controller 20 is pressed and the key is pressed for the predefined time period, in block S106, the determining module 12 determines whether the pressed key is associated with a first widget from the plurality of the widgets according to the association relationship between the widgets and the keys of the remote controller 20.

If the pressed key is associated with a first widget from the plurality of the widgets, in block S108, the starting module 13 determines whether the widget associated with the pressed key is started.

If the widget associated with the pressed key is not started, the starting module 13 starts and shows the associated widget on display screen 15 as shown in block S110.

If the widget associated with the pressed key is started, the starting module 13 closes and hides the associated widget on display screen 15 as shown in block S112.

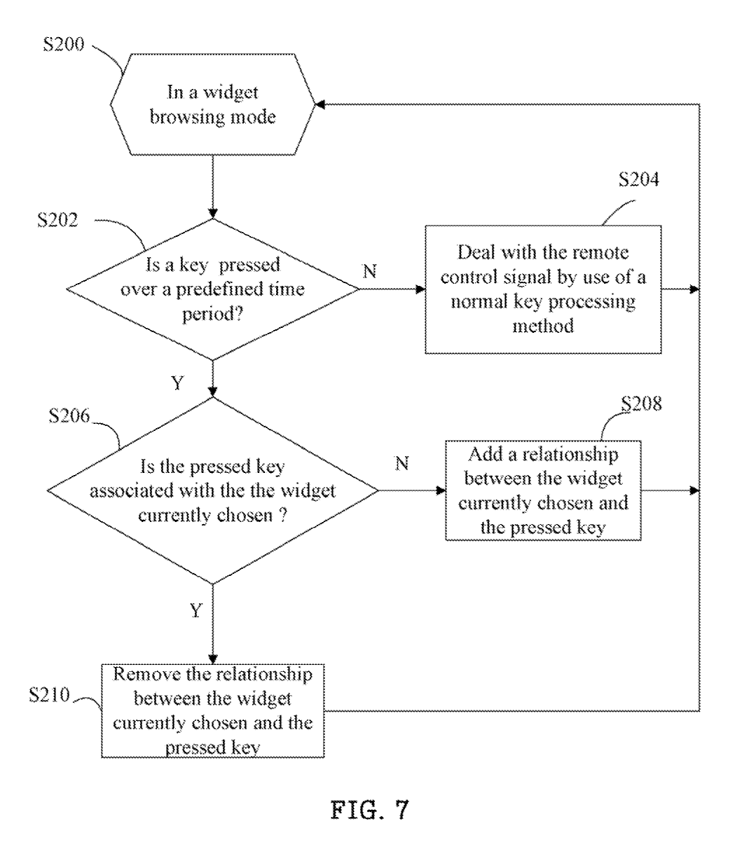

FIG. 7 is a flowchart of one embodiment of a method for setting the association relationship between the widgets of the electronic device 10 and the keys of the remote controller 20 when the electronic device 10 is in the widget browsing mode in accordance with the present disclosure.

In block S200, the electronic device 10 is started and enters a widget browsing mode, and one widget has been chosen.

In block S202, the determining module 12 determines receive a remote control signal that is indicative of a pressed key of the remote controller 20, and whether the pressed key is pressed for a predefined time period.

If the determining module 12 receives a remote control signal comprising a first key from the plurality of the keys of the remote controller 20 is pressed, but the key is not pressed for the predefined time period, the determining module 12 deals with the remote control signal by use of a normal key processing method as shown in block S204. In one embodiment, the normal key processing method of block S204 is the same as that of block S104, so detailed description is omitted.

If the determining module 12 receives a remote control signal comprising one key of the remote controller 20 is pressed and the key is pressed for the predefined time period, in block S206, the determining module 12 further determines whether the pressed key is associated with the widget currently chosen according to the association relationship between the widgets and the keys of the remote controller 20.

If the pressed key is not associated with the widget currently chosen, in block S208, the setting module 11 sets the pressed key to associate with the widget currently chosen. That is, the setting module 11 adds a relationship between the widget currently chosen and the pressed key.

If the pressed key is associated with the widget currently chosen, the setting module 11 removes the association relationship between the pressed key and the widget currently chosen as shown in block S210.

While various embodiments and methods of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. An electronic device controlled by a remote controller comprising a plurality of keys, the electronic device comprising:
at least one processor;
a storage system;
one or more programs that are stored in the storage system and are executed by the at least one processor, the one or more programs comprising:
a plurality of widgets;
a setting module operable to associate a relationship between the widgets and the keys of the remote controller when the electronic device is in a widget browsing mode;
a determining module operable to determine receive a remote control signal that is indicative of a pressed key of the remote controller, and to further determine whether the pressed key is pressed for a predefined time period, and whether the pressed key is associated with a first widget from the plurality of the widgets according to the relationship between the widgets and the keys; and
a starting module operable to start the first widget associated when the pressed key associated with the first widget is pressed for the predefined time period when the electronic device is in a full screen TV mode.

2. The electronic device as described in claim 1, wherein the determining module is further operable to determine whether the widget associated with the pressed key is started upon receiving the remote control signal, and the starting module is further operable to close the associated widget if the associated widget is started.

3. The electronic device as described in claim 1, wherein the setting module is further operable to add, modify and remove the association relationship between the widgets and the keys of the remote controller.

4. The electronic device as described in claim 1, wherein the setting module associate the relationship between the widgets and the keys of the remote controller when a first key from the plurality of the keys of the remote controller corresponding to a first widget from the plurality of the widgets is pressed for the predefined time period in the widget browsing mode.

5. The electronic device as described in claim 1, further comprising a display screen to display the widgets.

6. The electronic device as described in claim 1, wherein positions of the widgets displaying on the display screen correspond to positions of the associated keys in the remote controller.

7. A method for fast starting widgets of an electronic device, the electronic device comprising a plurality of widgets and being controlled by a remote controller comprising a plurality of keys, the method comprising:
associating a relationship between the widgets and the keys of the remote controller when the electronic device is in a widget browsing mode;
receiving a remote control signal comprising a first key from the plurality of the keys of the remote controller being pressed from the remote controller;
determining whether the pressed key is pressed for a predefined time period;
determining whether the pressed key is associated with a first widget from the plurality of the widgets according to the association relationship if the pressed key is pressed for the predefined time period; and
starting the first widget associated with the pressed key when the electronic device is in a full screen TV mode.

8. The method as described in claim 7, further comprising steps of:
determining whether the widget associated with the pressed key is started upon receiving the remote control signal; and
closing the associated widget if the associated widget is started.

9. The method as described in claim 7, wherein the step of associating the relationship between the widgets and the keys of the remote controller comprises:
adding, modifying and deleting the association relationship between the widgets and the keys of the remote controller.

10. The method as described in claim 7, wherein the step of associating the relationship between the widgets and the keys of the remote controller comprises:
associating the relationship between the widgets and the keys of the remote controller when a first key from the plurality of the keys of the remote controller is pressed for the predefined time period and associated with a first widget from the plurality of the widgets.

11. The method as described in claim 10, further comprising:
providing a display screen to display the widgets, wherein positions of the widgets displaying on the display screen correspond to positions of the associated keys in the remote controller.
